(19) United States
(12) Patent Application Publication
(10) Pub. No.: US 2025/0137235 A1
(43) Pub. Date: May 1, 2025

(54) EXCAVATOR AND EXCAVATOR OPERATION CONTROL SYSTEM

(71) Applicant: SUMITOMO CONSTRUCTION MACHINERY CO., LTD., Tokyo (JP)

(72) Inventor: Yuiki MATSUHASHI, Chiba (JP)

(21) Appl. No.: 18/931,630

(22) Filed: Oct. 30, 2024

(30) Foreign Application Priority Data
Oct. 31, 2023 (JP) 2023-187092

(51) Int. Cl. E02F 9/26; E02F 3/32; E02F 9/20; G06F 3/14

(52) U.S. Cl. CPC E02F 9/26; E02F 3/32; E02F 9/2004; E02F 9/205; G06F 3/14

(57) ABSTRACT

An excavator includes a lower travel body, an upper slewing body mounted on the lower travel body in a slewable manner, an attachment attached to the upper slewing body, a work tool provided at a distal end of the attachment, a drive source, a push button for starting the drive source, and a control section including a memory and a processor coupled to the memory, the control section being configured to issue a notification regarding a method for starting the drive source in response to receipt of a predetermined operation on the push button.

### CROSS-REFERENCE TO RELATED APPLICATIONS

Priority is claimed to Japanese Patent Application No. 2023-187092, filed Oct. 31, 2023, the entire content of which is incorporated herein by reference.

### BACKGROUND

### 1. Technical Field

The present disclosure relates to an excavator and an excavator operation control system.

### 2. Description of Related Art

As a method of activating an excavator, inserting an engine key into a key switch and turning the engine key to a position where the engine is started, is known.

In recent years, automobiles tend to have a push button start feature and have no key cylinder. Along with this trend, excavators tend to have a push button start feature, and are not equipped with a key cylinder.

However, since excavators are not commonly implemented with a push start feature, it may be difficult for an operator to understand how to start the excavator when the operator boards the excavator implemented with a push start button.

### SUMMARY

An excavator includes a lower travel body, an upper slewing body mounted on the lower travel body in a slewable manner, an attachment attached to the upper slewing body, a work tool provided at a distal end of the attachment, a drive source, a push button for starting the drive source, and a control section including a memory and a processor coupled to the memory, the control section being configured to issue a notification regarding a method for starting the drive source in response to receipt of a predetermined operation on the push button.

### BRIEF DESCRIPTION OF THE DRAWINGS

FIG. 1 is a side view of an excavator according to a first embodiment;

FIG. 2 is a diagram illustrating a configuration example of a drive control system of the excavator according to the first embodiment;

FIG. 3 is a plan view illustrating the interior of a cab according to the first embodiment;

FIG. 4A is a diagram illustrating an example of a screen display displayed by the display device according to the first embodiment in the case where a smart key for starting the excavator cannot be detected inside the cab of the excavator;

FIG. 4B is a diagram illustrating an example of a screen display displayed in the case where the display device according to the first embodiment detects an absence of the gate lock lever at the lock position;

FIG. 4C is a diagram illustrating an example of a screen display displayed by the display device according to the first embodiment in the case where a time period during which the push start button is pressed (turned on) is shorter than a time period during which the engine is started;

FIG. 5 is a flowchart illustrating a processing procedure for starting the engine performed by a controller according to the first embodiment; and

FIG. 6 is a schematic diagram illustrating a configuration example of a remote support system for an excavator according to a second embodiment.

### DETAILED DESCRIPTION

In one aspect of the present disclosure, an operator who boards an excavator is made to recognize how to start the excavator so that they can start work immediately, thereby improving work efficiency.

Hereinafter, embodiments of the present disclosure will be described with reference to the drawings. The embodiments described hereinafter are not intended to limit the invention but are merely examples, and all features and combinations thereof described in the embodiments are not necessarily essential to the invention. In the drawings, the same or corresponding components are denoted by the same or corresponding reference numerals, and the description thereof may be omitted.

In the following embodiments of the present disclosure, an example of using an excavator as an example of a work machine will be described; however, the work machine is not limited to an excavator. The present disclosure may be applied to a construction machine, a standard machine, an applied machine, a forestry machine, or a conveyance machine based on a hydraulic excavator.

### First Embodiment

Hereinafter, embodiments for carrying out the invention will be described with reference to the drawings.

### <Outline of Excavator>

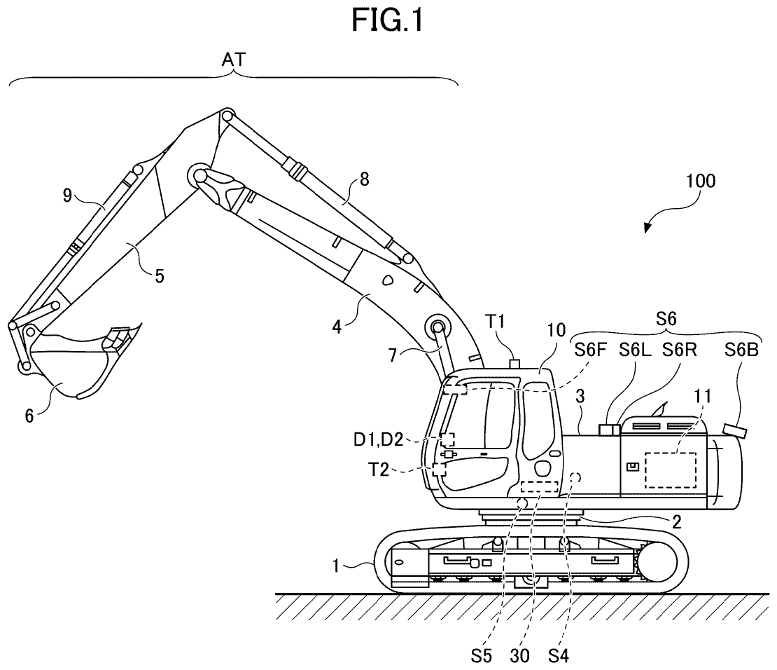

First, an overview of an excavator 100 according to the present embodiment will be described with reference to FIG. 1.

FIG. 1 is a side view of the excavator 100 according to the present embodiment.

The excavator 100 according to the present embodiment includes a lower travel body 1 and an upper slewing body 3 mounted on the lower travel body 1 in a slewable manner via a slewing mechanism 2, as well as a boom 4, an arm 5, and a bucket 6 as attachments (work devices), and a cab 10.

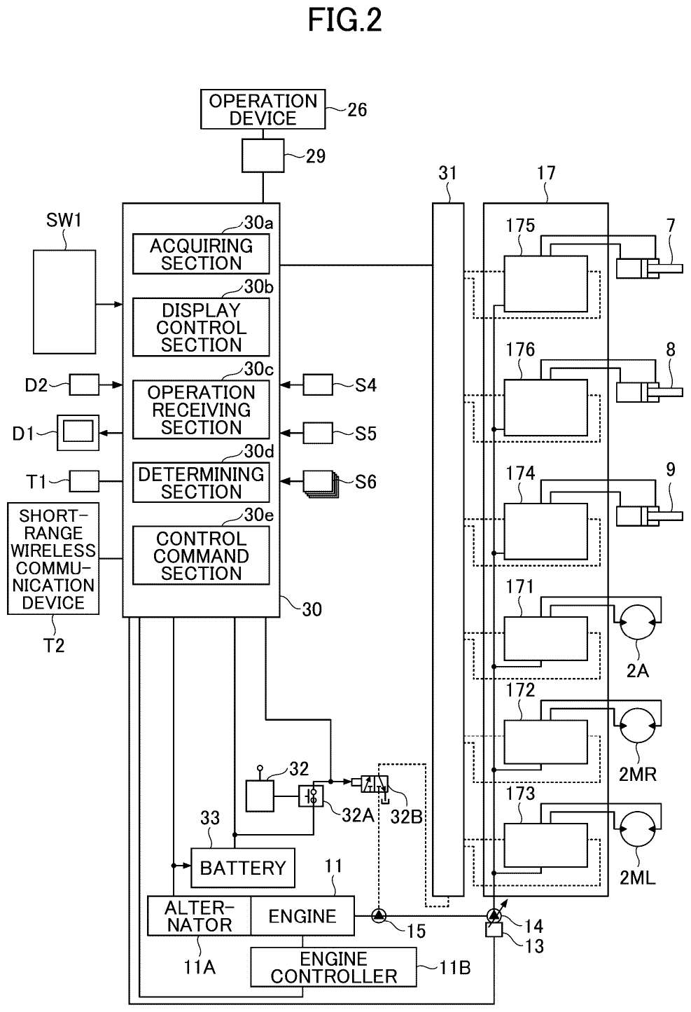

The lower travel body 1 (an example of a travel body) includes, for example, a pair of a left crawler and a right crawler, and the excavator 100 is caused to travel by hydraulically driving the respective crawlers with travel hydraulic motors 2ML and 2MR (see FIG. 2).

The upper slewing body 3 (an example of a slewing body) slews with respect to the lower travel body 1 by being driven by a slewing hydraulic motor 2A (see FIG. 2).

The attachment AT (an example of an attachment) includes the boom 4, the arm 5, and the bucket 6.

The boom 4 is attached to the center of the front portion of the upper slewing body 3 in an elevatable manner, the arm 5 is attached to the distal end of the boom 4 in a vertically rotatable manner, and the bucket 6 is attached to the distal end of the arm 5 in a vertically rotatable manner.

Further, instead of the bucket 6, another work tool may be attached to the distal end of the arm 5 depending on the work content or the like. The other work tool may be another type of bucket, such as a large bucket, a slope bucket, a dredging bucket, or the like. The other work tool may be a work tool of a type other than a bucket, such as a stirrer, a breaker, a grapple, or the like.

The boom 4, the arm 5, and the bucket 6 are hydraulically driven by a boom cylinder 7, an arm cylinder 8, and a bucket cylinder 9, respectively, as hydraulic actuators, with hydraulic oil discharged from a main pump 14 (see FIG. 2).

The cab 10 is a control room where an operator boards, and is mounted on the left side of the front portion of the upper slewing body 3.

The excavator 100 may be configured such that some of the driven elements, such as the lower travel body 1, the upper slewing body 3, the boom 4, the arm 5, and the bucket 6 are electrically driven. In other words, the excavator 100 may be a hybrid excavator, an electric excavator, or the like in which a part of the driven elements is driven by an electric actuator.

The machine body inclination sensor S4 detects an inclination state of a machine body (the upper slewing body 3 or the lower travel body 1) with respect to a horizontal plane. The machine body inclination sensor S4 is attached to, for example, the upper slewing body 3, and detects inclination angles (hereinafter, referred to as a “front-rear inclination angle” and a “left-right inclination angle”) around two axes in the front-rear direction and the left-right direction of the excavator 100 (that is, the upper slewing body 3). The controller 30 receives detection signals corresponding to inclination angles (the front-rear inclination angle and the left-right inclination angle) from the machine body inclination sensor S4.

The slewing angle sensor S5 outputs detection information regarding a slewing state of the upper slewing body 3. The slewing angle sensor S5 detects, for example, a slewing angular speed and a slewing angle of the upper slewing body 3. The slewing angle sensor S5 includes, for example, a gyro sensor, a resolver, a rotary encoder, and the like.

The imaging device S6 images areas around the excavator 100. The imaging device S6 includes a camera S6F that images an area in front of the excavator 100, a camera S6L that images an area to the left side of the excavator 100, a camera S6R that images an area to the right side of the excavator 100, and a camera S6B that images an area to the rear of the excavator 100.

The camera S6F is attached to, for example, the ceiling of the cab 10, that is, inside the cab 10. The camera S6F may be attached to the outside of the cab 10, such as the roof of the cab 10 or the side surface of the boom 4. The camera S6L is attached to the left end of the upper surface of the upper slewing body 3; the camera S6R is attached to the right end of the upper surface of the upper slewing body 3; and the camera S6B is attached to the rear end of the upper surface of the upper slewing body 3.

Each of the imaging devices S6 (cameras S6F, S6B, S6L, and S6R) is, for example, a monocular wide-angle camera having a very wide angle of view. The imaging devices S6 may be a stereo camera, a range image camera, or the like. The images captured by the imaging devices S6 are taken into the controller 30.

### <Configuration of Excavator>

Next, a specific configuration of the excavator 100 will be described with reference to FIG. 2 in addition to FIG. 1. FIG. 2 is a diagram illustrating a configuration example of a drive control system of the excavator 100 according to the first embodiment.

A cab 10 as an operator's cab, an engine 11, and the like are mounted on the upper slewing body 3. A controller 30 is mounted inside the cab 10. An operator's seat, an operation device, and the like are installed in the cab 10.

The controller 30 is a calculation device that executes various calculations. The controller 30 is provided inside the cab 10, for example, and performs drive control of the excavator 100. The function of the controller 30 may be implemented by any hardware, software, or a combination thereof. For example, the controller 30 may be mainly made up of a microcomputer including memory devices, such as a central processing unit (CPU), random access memory (RAM), and the like, a nonvolatile auxiliary storage device such as a solid state drive (SSD), an interface device for various inputs and outputs, and the like. The controller 30 realizes various functions by executing various programs installed in a nonvolatile auxiliary storage device on the CPU, for example.

The drive system of the excavator 100 according to the present embodiment includes an engine 11, a regulator 13, a main pump 14, and control valves 17. The hydraulic drive system of the excavator 100 according to the present embodiment includes hydraulic actuators such as a slewing hydraulic motor 2A, a boom cylinder 7, an arm cylinder 8, and a bucket cylinder 9 that hydraulically drive the upper slewing body 3, the boom 4, the arm 5, and the bucket 6, respectively.

The engine controller 11B performs drive control of the engine 11 based on various kinds of information input from the controller 30 (for example, a control command including a set rotational speed of the engine 11, an operation mode of the excavator corresponding to the set rotational speed of the engine 11, and the like). Specifically, the engine controller 11B realizes the drive control of the engine 11 by outputting control commands to actuators, such as a fuel injection device of the engine 11 as a control target and a starting motor for starting the engine 11.

For example, the engine controller 11B performs control to start the engine 11 in accordance with a control command from the controller 30.

The engine 11 is an example of a drive source of the excavator 100. The engine 11 is a main power source in the hydraulic drive system, and is mounted, for example, on a rear portion of the upper slewing body 3. In the present embodiment, the engine 11 is, for example, a diesel engine.

An output shaft of the engine 11 is connected to respective input shafts of the main pump 14 and the pilot pump 15. Specifically, the engine 11 rotates at a constant target rotation speed that is set in advance under direct or indirect control by the controller 30 (which is described later), and drives the main pump 14 and the pilot pump 15.

The engine 11 is provided with an alternator 11A. The alternator 11A generates electric power by using power of the engine 11 that is being driven. The electric power generated by the alternator 11A is used to charge the battery 33 or to supply electric power to electronic devices in the excavator 100. The alternator 11A transmits a signal indicating a voltage generated by the power generation to the controller 30.

The regulator 13 controls a discharge amount of the main pump 14. For example, the regulator 13 adjusts an angle (tilting angle) of the swashplate of the main pump 14 in response to a control command from the controller 30.

The main pump 14 is mounted on, for example, a rear portion of the upper slewing body 3 similarly to the engine 11, and supplies a hydraulic oil to the control valves 17 through a high-pressure hydraulic line. The main pump 14 is driven by the engine 11 as described above. The main pump 14 is, for example, a variable displacement hydraulic pump, and as described above, a stroke length of the piston is adjusted by a tilting angle of the swashplate being adjusted by the regulator 13 under the control of the controller 30, and a discharge flow rate (discharge pressure) is controlled.

The control valves 17 are a hydraulic control device that controls a hydraulic system in the excavator 100. In the present embodiment, the control valves 17 include control valves 171 to 176. The control valves 17 are configured to be able to selectively supply a hydraulic oil discharged by the main pump 14 to one or a plurality of hydraulic actuators through the control valves 171 to 176. The control valves 171 to 176 control, for example, a flow rate of a hydraulic oil flowing from the main pump 14 to the hydraulic actuator and a flow rate of the hydraulic oil flowing from the hydraulic actuator to a hydraulic oil tank. The hydraulic actuators include the boom cylinder 7, the arm cylinder 8, the bucket cylinder 9, the slewing hydraulic motor 2A, and the travel hydraulic motors 2MR and 2ML. Specifically, the control valve 171 corresponds to the slewing hydraulic motor 2A. The control valve 172 corresponds to the travel hydraulic motor 2ML, and the control valve 173 corresponds to the travel hydraulic motor 2MR. The control valve 174 corresponds to the bucket cylinder 9; the control valve 175 corresponds to the boom cylinder 7; and the control valve 176 corresponds to the arm cylinder 8.

The pilot pump 15 is an example of a pilot pressure generating device, and is configured to be able to supply a hydraulic oil to the hydraulic control device via a pilot line. In the present embodiment, the pilot pump 15 is a fixed displacement hydraulic pump.

A hydraulic oil supplied from the pilot pump 15 is supplied to the control valves 17 via a proportional valve 31. In the present embodiment, the controller 30 adjusts the opening area of the proportional valve 31 in accordance with an operation signal received from the operation device 26, which is described later. In this way, an example of adjusting a pilot pressure of a hydraulic oil by an electric operation lever will be described in the present embodiment. The pilot pressure generating device may be realized by the main pump 14. In other words, the main pump 14 may have a function of supplying a hydraulic oil flowing through the hydraulic oil line to the control valves 17, and a function of supplying a hydraulic oil to various hydraulic control devices via the pilot line. In this case, the pilot pump 15 may be omitted.

The operation device 26 is a device used by an operator to operate the actuator. Examples of the actuator are at least a hydraulic actuator or an electric actuator, or both of them.

The operation sensor 29 is configured to detect content of an operation performed by an operator using the operation device 26. The operation sensor 29 according to the present embodiment detects an operation direction and an operation amount of an operation lever of the operation device 26 corresponding to each of the actuators, and can output an operation signal indicating the detected value as an electric signal to the controller 30.

The controller 30 according to the present embodiment controls the opening area of the proportional valve 31 in accordance with the operation signal that is input from each of the operation sensors 29. The controller 30 supplies a hydraulic oil discharged from the pilot pump 15 to a pilot port of a corresponding control valve among the control valves 17. The pressure (pilot pressure) of a hydraulic oil supplied to each of the pilot ports is, in principle, a pressure corresponding to an operation direction and an operation amount of the operation lever corresponding to each of the hydraulic actuators. In this way, the controller 30 is configured to be able to supply a hydraulic oil discharged by the pilot pump 15 to the pilot port of a corresponding control valve among the control valves 17 based on an operation direction and an operation amount of the operation lever of the operation device 26.

The proportional valve 31 functioning as a control valve for machine control is disposed in a conduit connecting the pilot pump 15 to a pilot port of a control valve among the control valves 17, and is configured to be able to change a flow passage area of the conduit. In the present embodiment, the proportional valve 31 operates in response to a control command that is output from the controller 30.

A gate lock lever 32 is configured to be able to receive a manual tilting operation when an operator gets on and off the operator's seat in the cab 10.

The gate lock lever 32 is a mechanical input section (an example of an operating section) for switching between a release state in which the excavator 100 can be operated by the operation device 26 and a lock state in which the excavator 100 cannot be started and operated. In the present embodiment, the gate lock lever 32 that has been switched to the lock state in which operation is disabled is referred to as “the gate lock lever 32 is at the lock position”.

A gate lock switch 32A is switched between open and closed in accordance with a tilting operation performed on the gate lock lever 32. As a result, a signal indicating whether or not the gate lock lever 32 is at the lock position is output to the controller 30 and a gate lock control valve 32B.

The gate lock control valve 32B is provided partway in a pilot line connecting the pilot pump 15 and the proportional valve 31. When the gate lock switch 32A is in an off state, in other words, when the gate lock lever 32 is in the lock position, the gate lock control valve 32B stops the supply of a hydraulic oil (pilot pressure oil) from the pilot pump 15 to the proportional valve 31.

When the gate lock switch 32A is in an on state, in other words, when the gate lock lever 32 is in the release position, on the other hand, the gate lock control valve 32B supplies the hydraulic oil (pilot pressure oil) from the pilot pump 15 to the proportional valve 31.

Thus, the gate lock lever 32 is switched from a lock position in response to the operator pulling up the gate lock lever 32. Since the gate lock lever 32 is no longer at the lock position, a hydraulic oil (pilot pressure oil) can be supplied from the pilot pump 15 to the proportional valve 31, and it becomes therefore possible to perform drive control of the excavator 100. On the other hand, when the gate lock lever 32 is pulled down, the gate lock lever 32 is at the lock position. Therefore, when the operator sits on the operator's seat and pulls up the gate lock lever 32, the supply of the hydraulic oil (pilot pressure oil) from the pilot pump 15 to the proportional valve 31 is stopped, and thus the drive control of the excavator 100 is inhibited.

The battery 33 supplies electric power to various components in the excavator 100.

A display device D1 is provided at a position easily visible from a seated operator in the cab 10, and displays various information images under the control of the controller 30. The display device D1 may be connected to the controller 30 via an on-board communication network such as a controller area network (CAN), or via a dedicated line on a one-to-one basis.

The display device D1 is not limited to an apparatus provided in advance inside the cab 10, and may be a monitor that can be separately placed. Furthermore, the display device D1 may be any apparatus capable of displaying, and for example, a tablet apparatus or the like capable of communicating with a communication device T1 may be used.

An input device D2 is provided within reach of a seated operator in the cab 10, and configured to receive various operation inputs from the operator, and output signals corresponding to operation inputs to the controller 30. The input device D2 includes a touch panel implemented in a display area of the display device D1, a knob switch provided at a tip of a lever portion of the operation device 26, a button switch, a lever, a toggle, a rotary dial, and the like installed around the display device D1. A signal corresponding to content of an operation performed on the input device D2 is received by the controller 30.

The communication device T1 communicates with external devices via predetermined networks including a mobile communication network, a satellite communications network, the Internet, and the like. The communication device T1 is, for example, a mobile communication module compatible with a mobile communication standard, such as an LTE (Long Term Evolution), 4G (4th Generation), 5G (5th Generation) or a satellite communication module for connecting to a satellite communication network, or the like.

A short-range wireless communication device T2 is capable of communicating with a smart key (portable communication device) that can be carried by an operator, and detects whether or not the smart key (portable communication device) is present inside the cab 10. As a communication standard of the short-range wireless communication device T2, for example, Bluetooth (registered trademark) may be used, or another communication standard (e.g., Wi-Fi) may be used.

A push start button SW1 (an example of a push button) is a switch that can start the engine 11 in response to being pressed while the short-range wireless communication device T2 detects the smart key. An operator can start the engine 11 when performing a predetermined operation on the push start button SW1. The controller 30 illustrated in FIG. 2 starts the engine 11 when the push start button SW1 receives a predetermined operation and a condition for inhibiting the start of the engine 11 is not satisfied. In the present embodiment, since the push start function using the push start button SW1 is provided, the engine 11 can be started without a need to insert the engine key into the key switch, and improvement in convenience can be therefore realized.

The condition for inhibiting the start of the engine 11 is a condition determined based on safety and security for allowing an operator to operate the excavator 100.

In related art, an engine of an excavator is started by inserting an engine key into a key switch and turning the engine key to a position for starting the engine. In the case where the engine does not start even if an operator performs an engine start operation, the operator can assume that a gate lock lever is not at a lock position, and the operator can therefore start the engine of the excavator by setting the gate lock lever to a lock position.

However, in the case where a push start is implemented in the excavator, when the engine of the excavator cannot be started even if the push start is operated, it tends to be difficult for an operator to recognize the cause of not being able to start the engine of the excavator. For example, this is because the method for starting the engine of the excavator may differ depending on the provider of the excavator. For example, there is an excavator that requires a long press of the push start to start the engine, whereas there is also an excavator that requires a press of the push start after performing a pre-operation for enabling the push start to start the engine.

Furthermore, since the start of the engine of the excavator is nowadays controlled by software, it is conceivable that the condition for starting the engine varies between excavators in order to secure either one or both of safety and security.

In other words, in the case where the operator performs an operation to start the engine of the excavator but the engine is not started, a situation occurs in which the operator cannot guess how to start the engine.

Therefore, the controller 30 according to the present embodiment notifies the operator of a method for starting the engine 11 in response to receipt of a predetermined operation from the operator before the engine 11 is started in the case where a condition for inhibiting the start of the engine 11 is satisfied.

In the present embodiment, the controller 30 inhibits the start of the engine 11 in the case where the smart key is not present in the cab, the gate lock lever 32 is not at the lock position, or the push start button SW1 is not held down until the engine 11 is started. Note that the present embodiment represents an example of a condition for inhibiting the start of the engine 11, but the condition is not limited to this one, and other conditions may be used.

In the present embodiment, a predetermined operation on the push start button SW1 is a long press operation continued for a reference length of time or longer. In other words, the engine 11 is started in the case where the push start button SW1 is pressed for a reference length of time or longer. After starting of the engine 11 is initiated, the operator needs to continue pressing the push start button SW1 until the engine 11 is actually started.

The push start button SW1 may be used for operations other than starting the engine 11. For example, the push start button SW1 may be used as a switch for activating an ACC power supply. For example, when the push start button SW1 is pressed for a length of time shorter than a reference length of time, the starting of the engine 11 may be inhibited and the ACC power supply may be activated. The ACC power supply is an example of an accessory power supply that can supply a current to an electrical component mounted on the excavator 100. Examples of the electrical components mounted on the excavator 100 include a light, a radio, an air conditioner, the display device D1, and the like.

The push start button SW1 is also a switch used to stop the engine 11. The operator can stop the engine 11 by pressing the push start button SW1. The controller 30 can stop the engine 11 in response to receipt of an end operation of the push start button SW1 in a state where the engine 11 has been started. The end operation may be the same operation as the predetermined operation or may be an operation different from the predetermined operation. For example, the end operation for stopping the engine 11 may be a long press operation, a double click operation, or a single press operation.

The predetermined operation for starting the engine 11 is not limited to a long press of the push start button, and may be, for example, pressing of the push start button after a predetermined pre-operation is performed. The pre-operation may be an operation on a member in the vicinity of the push start button, a slide operation or a double click on the push start button, or the like.

A length of time for which the push start button SW1 is continuously pressed varies depending on a current state of the excavator 100. Specifically, the engine 11 may be easily started or may be difficult to start, depending on the temperature of the external environment of the excavator 100. For example, the engine 11 tends to be less easy to start in winter than in summer. Thus, the length of time for which the push start button SW1 is continuously pressed until the engine 11 is started varies depending on the season. For this reason, there is a case where an operator does not know the cause of the engine 11 not being started even though they have held down the push start button SW1.

To address such a situation, the controller 30 according to the present embodiment is configured to notify the operator of a method for starting the engine 11 (an example of the drive source) upon receipt of a long press operation (an example of the predetermined operation) on the push start button SW1. In the present embodiment, an example in which notification is performed when the engine 11 is not started even though the push start button SW1 is held down will be described. However, the present embodiment is not limited to the method of notifying the operator when the engine 11 is not started even though the push start button SW1 is held down. In the case where the push start button SW1 is held down, the notification may be performed regardless of whether the engine 11 is started. For example, the operator can know the reason why the engine 11 can be started by referring to the notification when the engine 11 is started.

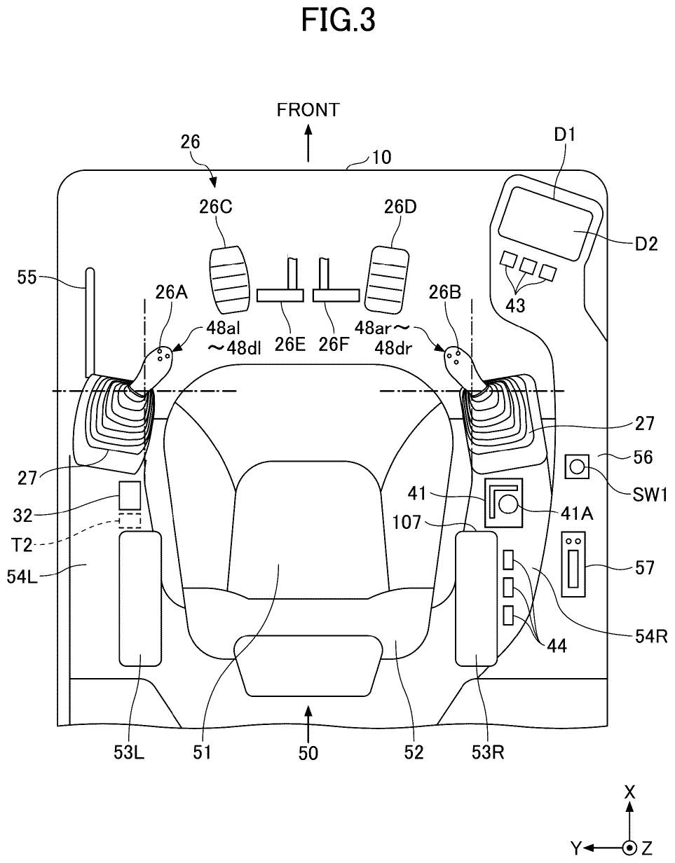

Next, the interior of the cab 10 will be described with reference to FIG. 3. FIG. 3 is a plan view illustrating the interior of the cab 10 according to the first embodiment. The excavator 100 includes an operator's seat 50, the operation device 26, and the display device D1, which are arranged inside the cab 10. An entrance door is provided on a side surface to the left of the operator's seat 50. An operator opens the entrance door to enter inside the cab 10.

The operator's seat 50 is arranged at the center of the cab 10 in a plan view. The operator's seat 50 includes a seat 51 on which an operator sits and a backrest 52. The operator's seat 50 is a reclining seat, and the inclination angle of the backrest 52 is adjustable. A left arm rest 53L is disposed on the left side of the operator's seat 50, and a right arm rest 53R is arranged on the right side of the operator's seat 50. The left arm rest 53L and the right arm rest 53R are rotatably supported by the backrest 52.

A console 54L is arranged on the left side of the operator's seat 50, and a console 54R is arranged on the right side of the operator's seat 50. The consoles 54L and 54R extend along the front-rear direction of the operator's seat 50. The operator's seat 50 is slidable in the front-rear direction. The operator's seat 50 may be configured to be slidable in the front-rear direction together with the consoles 54L and 54R.

The left arm rest 53L is arranged on the left console 54L. The right arm rest 53R is arranged on the left console 54R. The left arm rest 53L is arranged so as to cover a part of the left console 54L in a plan view. The left arm rest 53R is arranged so as to cover a part of the left console 54R in a plan view.

The operation device 26 includes a left operation lever 26A, a right operation lever 26B, a left travel pedal 26C, a right travel pedal 26D, a left travel lever 26E, and a right travel lever 26F.

The left operation lever 26A is provided at a front portion of the left console 54L. Similarly, the right operation lever 26B is provided at a front portion of the right console 54R. An operator seated on the operator's seat 50 can operate the left operation lever 26A while gripping the left operation lever 26A with their left hand, and can operate the right operation lever 26B while gripping the right operation lever 26B with their right hand. An operator seated on the operator's seat 50 can operate the left operation lever 26A with their left hand to drive the arm cylinder 8 and the slewing hydraulic motor. An operator seated on the operator's seat 50 can operate the right operation lever 26B with their right hand to drive the boom cylinder 7 and the bucket cylinder 9. The base of each of the left operation lever 26A and the right operation lever 26B is covered with a lever boot 27. The present embodiment is an example of the operation mode, and the present disclosure is not limited to this operation mode.

The left travel pedal 26C and the right travel pedal 26D are arranged on the floor surface in front of the operator's seat 50. An operator seated on the operator's seat 50 can operate the left travel pedal 26C with their left foot to drive the left travel hydraulic motor 2ML. An operator seated on the operator's seat 50 can operate the right travel pedal 26D with their right foot to drive the right travel hydraulic motor 2MR.

The left travel lever 26E and the right travel lever 26F are arranged between the left travel pedal 26C and the right travel pedal 26D in a plan view. The left travel pedal 26C and the right travel pedal 26D extend upward from the floor surface in front of the operator's seat 50. An operator seated on the operator's seat 50 can drive the left travel hydraulic motor 2ML by operating the left travel lever 26E while gripping the left travel lever 26E with their left hand, similarly to the operation with the left travel pedal 26C. An operator seated on the operator's seat 50 can drive the right travel hydraulic motor 2MR by operating the right travel lever 26F while gripping the right travel lever 26F with their right hand, similarly to the operation with the right travel pedal 26D.

The display device D1 is disposed in front and on the right side of the operator's seat 50. The display device D1 displays various kinds of image information. The display device D1 displays information such as a work condition or an operation state of the excavator 100 as image information. The operator seated on the operator's seat 50 can perform work with the excavator 100, checking various kinds of information displayed on the display device D1. An operating section 43 may be provided on the display device D1.

The gate lock lever 32 is provided between the left operation lever 26A (including the lever boot 27) and the left arm rest 53L on the console 54L on the left side of the operator's seat 50. Pulling up the gate lock lever 32 brings the gate lock lever 32 into an unlocked state. The hydraulic actuator thereby becomes operable, and the operator can operate the excavator 100. Pushing down the gate lock lever 32 brings the gate lock lever 32 into a locked state. The hydraulic actuator thereby becomes inoperable, and the operator cannot operate the excavator 100. In this way, unless an operator sits on the operator's seat 50 and pulls up the gate lock lever 32, the excavator 100 does not operate, and the safety of a worker or the like who works in the proximity of the excavator 100 is maintained. In the present embodiment, an aspect in which the gate lock lever is used to switch between the unlocked state and the locked state has been described. However, the present embodiment does not limit the mode of switching between the unlocked state and the locked state, and the unlocked state and the locked state may be switched using other modes.

As described later, the excavator 100 can receive a long press (an example of a predetermined operation) for starting the engine 11, when the gate lock lever is at the lock position. In the excavator 100, the engine 11 cannot be started when the gate lock is in an unlocked state.

A gate bar 55 is provided on the left side of the operator's seat 50 (i.e., the side where the entrance door is provided in the cab 10).

The gate bar 55 operates in conjunction with an operation state of the gate lock lever 32 provided on the console 54L. The gate bar 55 is attached to a frame inside the console 54L so as to be able to rise and fall centered on an axis in the left-right direction of the upper end portion.

In the case where the gate lock lever 32 is in a state in which the excavator 100 can be operated, the gate bar 55 is in a state (the state illustrated in FIG. 3) in which the gate bar 55 is raised forward so as to block the left-right movement between the operator's seat 50 and the entrance of the cab 10. On the other hand, in the case where the gate lock lever 32 is in a state in which the excavator 100 cannot be operated (a lock position), the gate bar 55 is accommodated in the console 54L in a state of being laid downward so as to allow the gate bar 55 to move in the left-right direction between the operator's seat 50 and the entrance of the cab 10. Thus, an operator cannot operate the excavator 100 unless the gate bar 55 is in a state of protruding forward in accordance with the operation of the gate lock lever 32, and the safety of the excavator 100 is improved.

The short-range wireless communication device T2 may be provided inside the console 54L, and the radio waves that are output from the short-range wireless communication device T2 may have directivity. For example, the short-range wireless communication device T2 may be configured to be communicable only with a communication device present in the cab 10. Thus, the short-range wireless communication device T2 can detect a smart key (portable communication device) possessed by the operator seated on the operator's seat 50.

The controller 30 according to the present embodiment enables the engine 11 to start in response to detection of a smart key in the cab 10 by the short-range wireless communication device T2.

A window-side console 56 is installed on the right side of the console 54R. The window-side console 56 extends over the entire length of the cab 10 in the front-rear direction and is provided in parallel with the console 54R. The display device D1 is installed in front of the window-side console 56. A radio 57 and the like are installed in the window-side console 56. The radio 57 and the like may be installed in the console 54L or the console 54R.

The excavator 100 includes a switch panel 41 disposed inside the cab 10. The switch panel 41 is disposed on the right-side console 54R. The switch panel 41 is disposed between the right operation lever 26B and the right arm rest 53R in a plan view.

The switch panel 41 includes a dial 41A. The dial 41A is cylindrical and rotatable. The dial 41A is an example of a rotary operating section that is axially rotatable. The dial 41A is an example of a throttle that can change the output of the drive source. The dial 41A includes an encoder capable of detecting a rotation angle of the dial 41A. The controller 30 detects a rotation angle of the dial 41A based on a value that is output by the encoder.

The push start button SW1 is provided at the window side console 56 on the side in front of the radio 57. The push start button SW1 can be operated by pushing.

In addition, a guide (not illustrated) may be provided on the outer periphery of the push start button SW1. The guide protrudes outward from the surface of the push start button SW1. The upper end of the guide protrudes upward from the push start button SW1. The push start button SW1 is disposed at a position lower than the upper end portion of the guide. This prevents an operator from touching the push start button SW1 by mistake.

### <Configuration Example of Control System of Excavator>

Returning to FIG. 2, the control system of the excavator 100 according to the present embodiment includes the controller 30, the display device D1, the input device D2, and the communication device T1.

The controller 30 is a control device for controlling the entire excavator 100. The controller 30 is connected to a display device D1. Various information is displayed on the display device D1.

The controller 30 (an example of a control device) is provided inside the cab 10, for example, and performs drive control of the excavator 100. The function of the controller 30 may be implemented by any hardware, software, or a combination thereof. For example, the controller 30 may be mainly made up of a microcomputer including a central processing unit (CPU), a random access memory (RAM), a read only memory (ROM), a nonvolatile auxiliary storage device, an interface device for various inputs and outputs, and the like. The controller 30 realizes various functions by executing various programs stored in a ROM or a nonvolatile auxiliary storage medium on the CPU, for example.

For example, the controller 30 sets a target rotation speed based on an operation by an operator or the like, and performs drive control to rotate the engine 11 at a constant speed.

Furthermore, for example, the controller 30 outputs a control command to the regulator 13 as necessary, and changes the discharge amount of the main pump 14.

Furthermore, for example, the controller 30 controls the regulator 13 and adjusts the discharge amount of the main pump 14 based on a detection value of a pilot pressure, which is input from the operation sensor 29 and corresponds to an operation state of various operation elements (that is, various hydraulic actuators) in the operation device 26.

Further, for example, the controller 30 performs control related to a machine guidance function of guiding a manual operation the excavator 100 that is input by an operator through the operation device 26. The controller 30 performs control related to a machine control function of automatically supporting a manual operation of the excavator 100 that is input by the operator through the operation device 26, for example.

Note that some of the functions of the controller 30 may be implemented by another controller (control device). That is, the functions of the controller 30 may be realized in a distributed manner by a plurality of controllers. For example, the machine guidance function and the machine control function may be realized by a dedicated controller (control device).

### <Functional Configuration of Controller>

A configuration for the controller 30 to start the engine 11 will be described. The controller 30 executes a program stored in a storage medium (not illustrated) to realize an acquiring section 30a, a display control section 30b, an operation receiving section 30c, a determining section 30d, and a control command section 30e.

The acquiring section 30a acquires detection results from various sensors provided in the excavator 100. For example, the acquiring section 30a acquires a detection result as to whether or not a smart key is present in the cab 10 from the short-range wireless communication device T2. The acquiring section 30a acquires a signal indicating whether or not the gate lock lever 32 is at the lock position from the gate lock switch 32A.

Other than those information items, the acquiring section 30a also acquires an inclination state of the excavator 100 from the excavator inclination sensor S4. The acquiring section 30a acquires a slewing angle of the upper slewing body 3 from the slewing angle sensor S5 (an example of an angle detecting device). Furthermore, the acquiring section 30a acquires image information indicating an imaging result from the imaging device S6.

The display control section 30b causes the display device D1 to display the detection results of the various sensors. For example, the display control section 30b causes the display device D1 to display image information indicating the imaging result on the imaging device S6.

The display control section 30b causes, before the engine 11 is started, the display device D1 to display a pop-up screen, which is indicated as text information indicating a method for starting the engine 11, in accordance with a determination result of the determining section 30d, which is described later. In the present embodiment, since the method for starting the engine 11 is displayed as text information on the display device D1, it is easy for an operator to recognize what operation is required to start the engine 11. Since the operator can immediately start the work, the work efficiency can be improved.

The operation receiving section 30c recognizes an operation received by the operation device 26 based on an operation signal from the operation sensor 29. The operation receiving section 30c recognizes the operation received by the input device D2 based on a signal from the input device D2.

The operation receiving section 30c recognizes whether or not the push start button SW1 is pressed based on a signal from the push start button SW1.

In the case where the excavator 100 is remotely operated, the operation receiving section 30c recognizes a received operation based on an operation signal received from an external device via the communication device T1.

The determining section 30d determines whether or not the condition for inhibiting the start of the engine 11 is satisfied based on detection results of the various sensors acquired by the acquiring section 30a and an operation received by the operation receiving section 30c.

The control command section 30e transmits a control command for operating a configuration in the excavator 100.

For example, in the case where the determining section 30d determines that the condition for inhibiting the start of the engine 11 is not satisfied (in other words, the condition for starting the engine 11 is satisfied), the control command section 30e transmits a control command for starting the engine 11 to the engine controller 11B.

The control command section 30e continues to transmit the control command for starting the engine 11 while the operation receiving section 30c is recognizing that the push start button SW1 is being pressed.

The control command section 30e ends the transmission of the control command in response to receipt of a signal indicating that the engine 11 has been started from the engine controller 11B.

In the case where the determining section 30d determines that the condition for inhibiting the start of the engine 11 is satisfied after the long press on the push start button SW1 is received, the display control section 30b causes the display device D1 to display a pop-up screen indicating a method for starting the engine 11. In other words, notifying an operator of a method for starting the engine 11 in the case where the engine 11 cannot be started allows the operator to recognize the reason why the engine 11 cannot be started through content of the notification. Therefore, the operator can recognize what to do to start the engine 11. Thus, in the present embodiment, the engine 11 can be started easily and the work can be started immediately, so that the work efficiency can be improved.

The condition for inhibiting the start of the engine 11 (an example of the predetermined condition) is one or more of the following: a length of time during which the push start button SW1 is pressed (turned on) is shorter than a length of time necessary to get the engine 11 started; the gate lock lever 32 provided in the cab 10 of the excavator 100 is not in the lock position; and a smart key for starting the excavator 100 is not detected inside the cab 10 of the excavator 100.

There are a plurality of types of notifications performed by the display control section 30b according to the present embodiment. Upon receipt of a long press of the push start button SW1, in the case where the condition for inhibiting the start of the engine 11 is satisfied, the display control section 30b performs a notification corresponding to the condition among the plurality of types of notification. The notification indicates guidance on an operation to be performed by an operator to solve the condition and start the engine 11. The operator can thus recognize the operation to be performed according to the current situation by the notification, and is thus able to immediately start the engine 11. Therefore, the excavator 100 can immediately perform work, and improvement in work efficiency can thus be realized.

### <Example of Pop-Up Screen>

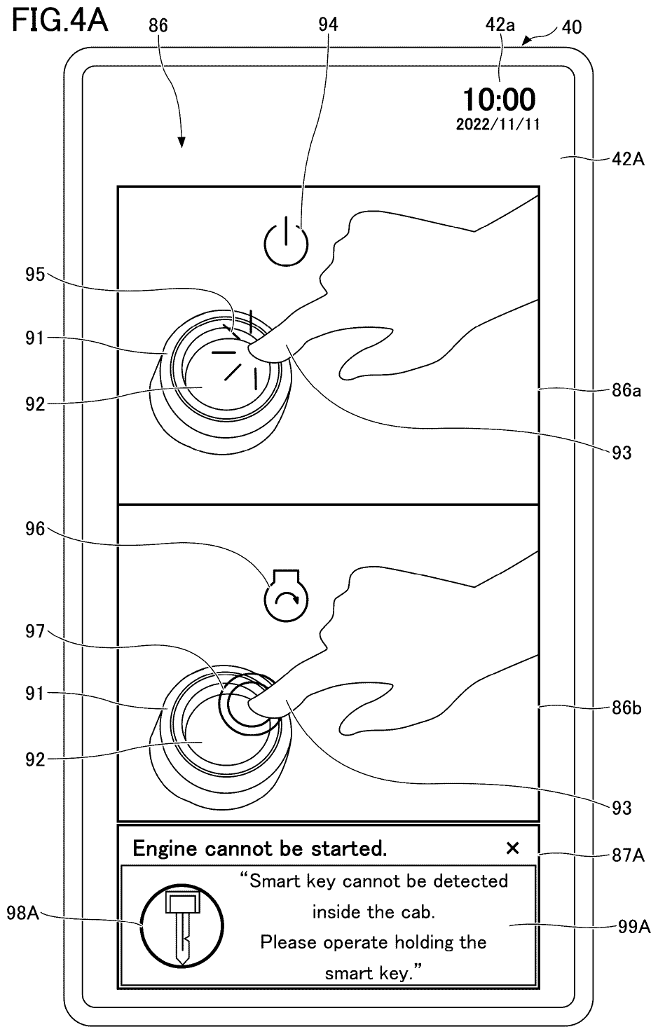

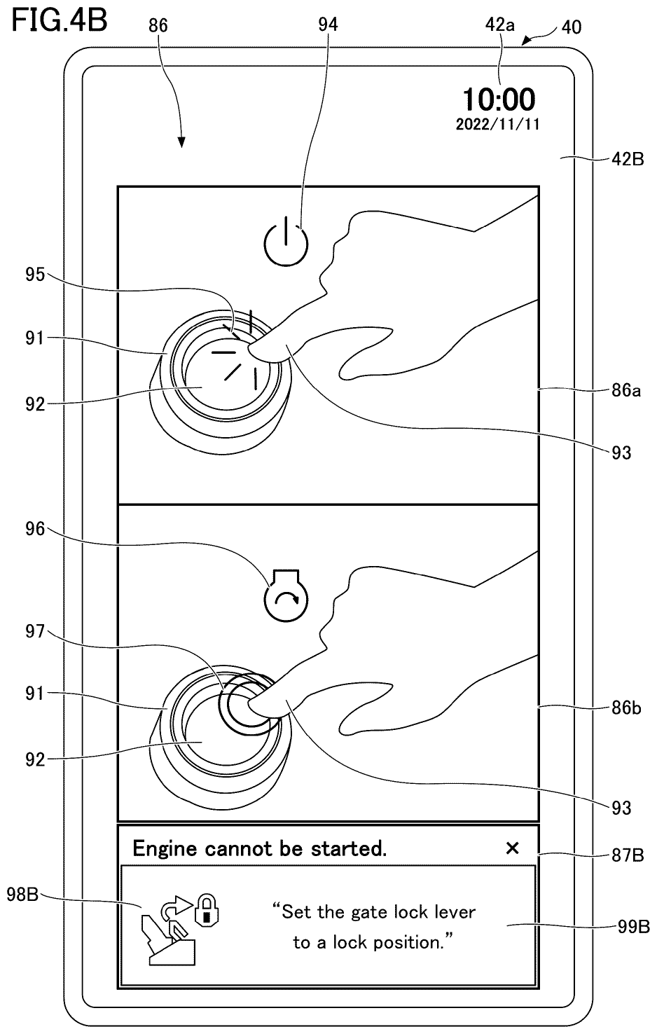

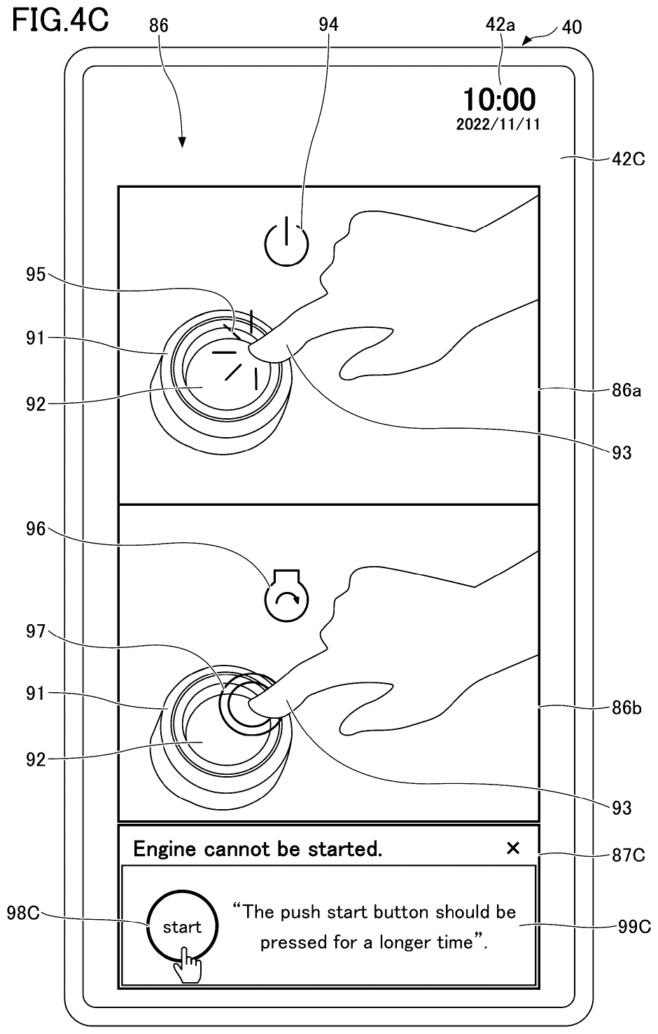

Next, a pop-up screen that is output by the display control section 30b will be described. FIG. 4A is a diagram illustrating an example of a screen display displayed by the display device D1 according to the first embodiment in the case where a smart key for starting the excavator 100 cannot be detected inside the cab 10 of the excavator 100. The image display portion 42A illustrated in FIG. 4A illustrates an example in which a pop-up screen 87A is superimposed on the start-up screen displayed after an operator opens the door and enters the cab 10. The state after an operator enters the cab 10 includes a state before the ACC power supply is activated and a state before the engine 11 is started.

The image display portion 42 includes time information 42a, a system activation guidance display area 86a, an engine start guidance display area 86b, and a pop-up screen 87A. The system activation guidance display area 86a and the engine start guidance display area 86b constitute an activation screen displayed after the operator enters the cab 10.

In the system activation guidance display area 86a, an image indicating an operation method for activating the system is displayed. The image showing the operation method for activating the system includes an image 92 showing the push start button SW1, an image 93 showing an operator's finger, an image 94 giving an operator an image of the activation of the system, and an image 95 giving an operator an image of an operator's finger pressing the push start button SW1. The image indicating the operation method at the time of activating the system may include other characters, figures, and the like. The image 95 that gives an operator an image of an operator's finger pressing the push start button SW1 may be, for example, a plurality of straight lines extending radially from the fingertip. The image 95 is not limited to a plurality of straight lines extending radially from the fingertip. The image 95 may be any image, and can be appropriately devised by those skilled in the art. The image indicating an operation method when the system is activated is not limited to this. Those skilled in the art can devise an image indicating an operation method for activating the system as appropriate. For example, a moving image may be displayed as an image indicating an operation method for activating the system, or sound may be output simultaneously with the image. The image indicating the operation method for activating the system may include character information.

An image indicating an operation method for starting the engine 11 is displayed in the engine start guidance display area 86b. The image showing an operation method for starting the engine 11 includes an image 92 showing the push start button SW1, an image 93 showing an operator's finger, an icon 96 giving an operator an image of the engine 11, and an image 97 giving an operator an image of an operator's finger pressing the push start button SW1. The image indicating the operation method at the time of starting the engine 11 may include other characters, figures, and the like. The image 97 that gives an operator an image of an operator's finger pressing the push start button SW1 may be, for example, a plurality of concentric circles around the fingertip. The image 97 is not limited to a plurality of concentric circles around the fingertip. The image 97 may be any image, and can be appropriately devised by those skilled in the art. An operator can easily understand an operation method for activating the system and an operation method for starting the engine 11 by viewing such a guidance screen 86. This prevents an operator from performing an erroneous operation. The image indicating an operation method for starting the engine 11 is not limited to this. A person who has ordinary skill in the art can devise an image indicating an operation method for starting the engine 11 as appropriate. For example, a moving image may be displayed as an image indicating an operation method for starting the engine 11, or sound may be output simultaneously with the image. The image indicating an operation method for activating the system may include character information.

The pop-up screen 87A is a screen displayed when a condition for inhibiting the start of the engine 11 (an example of a predetermined condition) is satisfied. The pop-up screen 87A is displayed in the case where the determining section 30d determines that the smart key for starting the excavator 100 is not detected inside the cab 10 of the excavator 100.

The pop-up screen 87A includes an icon 98A indicating a key and a message 99A. The message 99A indicates a method for starting the engine 11, saying “Smart key cannot be detected inside the cab. Please operate holding the smart key.” Thus, an operator can recognize that the engine 11 can be started by boarding the cab 10 while carrying the smart key and pressing the push start button SW1.

FIG. 4B is a diagram illustrating an example of a screen display displayed in the case where the display device D1 according to the first embodiment detects an absence of the gate lock lever 32 at the lock position. The image display portion 42B illustrated in FIG. 4B illustrates an example in which a pop-up screen 87B is superimposed on the start-up screen displayed after the operator opens the door and enters the cab 10.

The image display portion 42B includes time information 42a, a system activation guidance display area 86a, an engine start guidance display area 86b, and a pop-up screen 87B. The system activation guidance display area 86a and the engine start guidance display area 86b constitute an activation screen displayed after the operator enters the cab 10. The screen is as described above, and the description thereof is therefore omitted.

The pop-up screen 87B is a screen displayed because a condition for inhibiting the start of the engine 11 (an example of a predetermined condition) is satisfied. The pop-up screen 87B is displayed in the case where the determining section 30d determines that the gate lock lever 32 is not at the lock position.

The pop-up screen 87B shows an icon 98B indicating the lock of the gate lock lever 32 and a message 99B. The message 99B indicates the method for starting the engine 11, saying “Set the gate lock lever to lock position.” Therefore, an operator can recognize that the engine 11 can be started by pulling down the gate lock lever 32 to the lock position.

FIG. 4C is a diagram illustrating an example of a screen display displayed by the display device D1 according to the present embodiment when a length of time during which the push start button SW1 is pressed (turned on) is shorter than a length of time necessary to get the engine 11 started. The image display portion 42C illustrated in FIG. 4C illustrates an example in which a pop-up screen 87C is superimposed on the activation screen displayed after an operator opens the door and enters the cab 10.

The image display portion 42C includes time information 42a, a system activation guidance display area 86a, an engine start guidance display area 86b, and a pop-up screen 87C. The system activation guidance display area 86a and the engine start guidance display area 86b constitute an activation screen displayed after an operator enters the cab 10. The activation screen is as described above, and the description thereof is therefore omitted.

The pop-up screen 87C is a screen displayed because a condition for inhibiting the start of the engine 11 (an example of a predetermined condition) is satisfied. The pop-up screen 87C is displayed when the determining section 30d determines that a length of time during which the push start button SW1 is pressed (turned on) is shorter than a length of time necessary to get the engine 11 started.

The pop-up screen 87C shows an icon 98C indicating pressing of the push start button SW1, and a message 99C. The message 99C indicates that “The push start button should be pressed for a longer time”. Therefore, an operator can recognize that it is necessary to press the push start button SW1 for a longer time to start the engine 11.

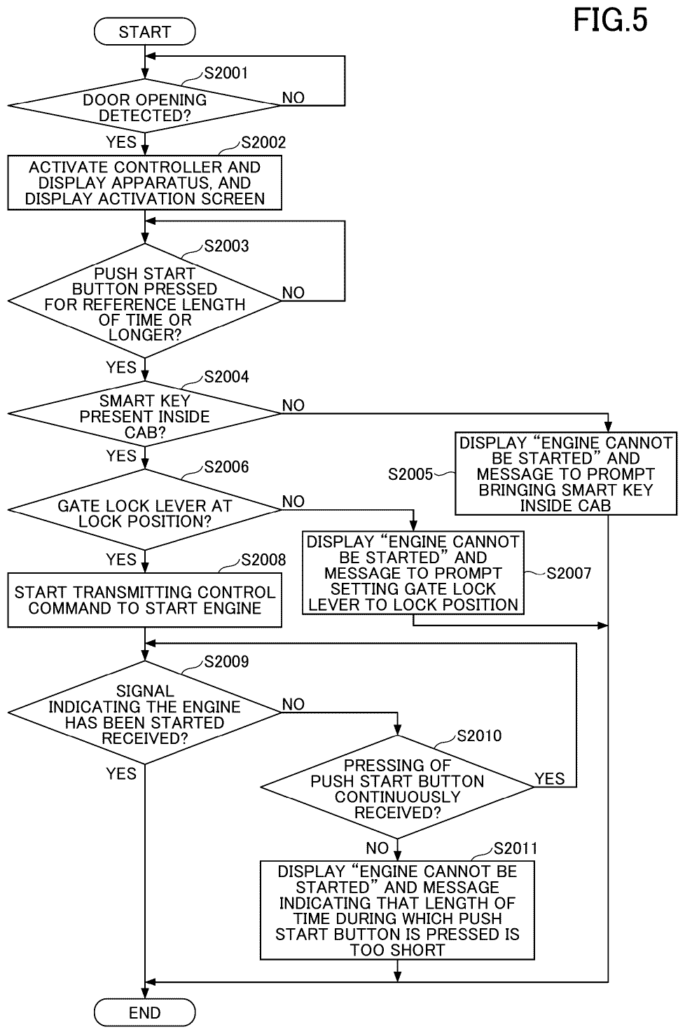

Next, a processing procedure for the controller 30 according to the present embodiment to start the engine 11 will be described. FIG. 5 is a flowchart illustrating a processing procedure for starting the engine 11 performed by the controller 30 according to the first embodiment.

A door switch (not illustrated) determines whether or not opening of the door of the cab 10 is detected (step S2001). In the case where the door switch determines that opening of the door of the cab 10 is not detected (NO in S2001), the process is repeated until the door opening is detected.

In the case where the door switch detects the opening of the door of the cab 10 (YES in S2001), the controller 30 and the display device D1 are activated, and the controller 30 causes the display device D1 to display an activation screen (S2002).

The operation receiving section 30c determines whether or not a pressing of the push start button SW1 for the reference length of time or longer has been received (S2003). In the case where the operation receiving section 30c determines that a pressing of the push start button SW1 for the reference length of time or longer has not been received (NO in S2003), the process is repeated until a pressing for the reference length of time or longer is received. In the case where the operation receiving section 30c has received a pressing for a length of time shorter than the reference length of time, the controller 30 may activate the ACC power supply.

In the case where the operation receiving section 30c determines that a pressing of the push start button SW1 for the reference length of time or longer has been received (YES in S2003), the determining section 30d determines whether or not a smart key for starting the excavator 100 is present in the cab 10 of the excavator 100 based on the detection result by the short-range wireless communication device T2 acquired by the acquiring section 30a (S2004).

In the case where the determining section 30d determines that the smart key is not present inside the cab 10 of the excavator 100 (NO in S2004), the display control section 30b displays a pop-up screen 87A for prompting the operator to bring the smart key to the cab 10 together with the notification that the engine 11 cannot be started (S2005), and the process is ended.

In the case where the determining section 30d determines that the smart key is present inside the cab 10 of the excavator 100 (YES in S2004), the determining section 30d determines whether or not the gate lock lever 32 is at the lock position based on the signal from the gate lock switch 32A acquired by the acquiring section 30a (S2006).

In the case where the determining section 30d determines that the gate lock lever 32 is not at the lock position (NO in S2006), the display control section 30b displays a pop-up screen 87B for prompting the operator to set the gate lock lever 32 to the lock position together with a notification that the engine 11 cannot be started (S2007), and the processing is ended.

In the case where the determining section 30d determines that the gate lock lever 32 is at the lock position (YES in S2006), the control command section 30e starts transmitting a control command for starting the engine 11 to the engine controller 11B (S2008).

The determining section 30d determines whether or not a signal indicating that the start of the engine 11 has been initiated has been received from the engine controller 11B (S2009).

In the case where the determining section 30d determines that a signal indicating that the start of the engine 11 has been initiated has not been received from the engine controller 11B (NO in S2009), the determining section 30d determines whether or not the operation receiving section 30c continuously receives the pressing of the push start button SW1 (S2010). In the case where the operation receiving section 30c determines that it continuously receives the pressing of the push start button SW1 (YES in S2010), the control command section 30e continuously transmits a control command for starting the engine 11, and the process returns to S2009 and is repeated.

In the case where the determining section 30d determines that the operation receiving section 30c does not continuously receive a pressing of the push start button SW1 (NO in S2010), the display control section 30b displays a pop-up screen 87C indicating that the engine 11 cannot be started and the time during which the push start button is pressed is short (in other words, prompting the operator to press the push start button for a longer time) (52011), and the process is ended. At this time, the control command section 30e also stops transmitting a control command for starting the engine 11 to the engine controller 11B.

On the other hand, in the case where the determining section 30d receives a signal indicating that the engine 11 has been started from the engine controller 11B (YES in S2009), the process is ended on the assumption that the engine 11 has been started.

The controller 30 according to the present embodiment can, through performing the above-described control, cause a pop-up screen for starting the engine 11 to be displayed in the case where the engine 11 cannot be started.

In the present embodiment, an example in which the start of the engine 11 is initiated by a long press of the push start button SW1 has been described. However, there are excavators in which the operation for starting the engine 11 is not a long press of the push start button SW1.

For example, there is also an excavator in which the engine is started by pressing a push start button after a pre-operation is received for a predetermined member present in the vicinity of the push start button. In this case, in response to receipt of the pressing of the push start button without the pre-operation having been performed on the predetermined member, the controller of the excavator may inhibit the start of the engine 11 and notify the display device of a prompt for the pre-operation on the predetermined member as the notification regarding the method for starting the engine.

### Modified Example 1 of First Embodiment

In the above-described embodiment, the method of displaying characters or the like on the display device D1 as the notification of the method for starting the engine 11 is described. However, the above-described embodiment is not limited to the method of displaying characters and the like on the display device D1.

As a modification, an operator may be notified by sound and light. The controller 30 according to the present modified example notifies an operator of a method for starting the engine 11 by voice from a speaker provided in the cab 10.

Furthermore, the controller 30 according to the present modified example notifies an operator of a method for starting the engine 11 by using a light source provided in the cab 10. For example, in the case where it is determined that the smart key cannot be detected, the controller 30 turns on a lamp indicating bringing of the smart key.

In the present modified example, the case where the controller 30 performs notification using sound and light has been described. In the present modified example, the notification is not limited to the notification using sound and light, and the notification may be performed by outputting any one of sound, light, or character information. The controller 30 according to the present modified example can notify the operator of a reason why the engine 11 cannot be started by any one of sound, light, or character information.

### Modified Example 2 of First Embodiment

In the above-described embodiment, the condition for inhibiting the start of the engine 11 is that the smart key is not present in the cab, the gate lock lever 32 is not in the lock position, or the push start button SW1 is not held down until the engine 11 is started. However, the condition for inhibiting the start of the engine 11 is not limited to these conditions. In this modified example, another example of the condition for inhibiting the start of the engine 11 will be described. The controller 30 according to the present modified example inhibits the start of the engine 11 in the case where the following conditions are satisfied.

The condition for inhibiting the start of the engine 11 according to the present modified example is, for example, one or more of the following: when it is detected that the seat belt is not worn; when a seating sensor provided in the operator's seat 50 of the cab 10 cannot detect that the operator is seated; when an alcohol detector provided in the cab 10 detects alcohol from the operator; when fatigue of the operator present in the cab 10 is detected; when drowsiness of the operator present in the cab 10 is detected; and when it is detected that the door of the cab 10 is open.

Furthermore, a result of personal authentication may be used for an operator present in the cab 10. Any method may be used as the personal authentication method, and face authentication may be performed by an imaging device in the cab. Suppose the condition for inhibiting the start of the engine 11 according to the present modified example depends on a result of the personal authentication, in other words, a case where it is determined that the person in the cab 10 is not permitted to operate.

The condition for inhibiting the start of the engine 11 is not limited to the above-described condition, and the current state of the excavator 100 may be included in a determination criterion. For example, the condition for inhibiting the start of the engine 11 may include a case where it is detected that a component of the excavator 100 is detached, and a case where that the engine 11 is diagnosed with a failure by the diagnosis system.

Then, in the case where the determining section 30d determines that the above-described condition is satisfied, the display control section 30b displays a pop-up screen indicating a method for starting the engine 11 corresponding to the condition on the display device D1. In the case where any one of the above-described conditions is satisfied, the controller 30 according to the present modified example displays a pop-up screen indicating a method for starting the engine 11 corresponding to the condition. Thus, it is possible to improve work efficiency or convenience by performing the same control as that in the foregoing embodiment in the case where various conditions are satisfied.

### Second Embodiment

In the second embodiment, a case where an operator remotely operates the excavator 100 is described.

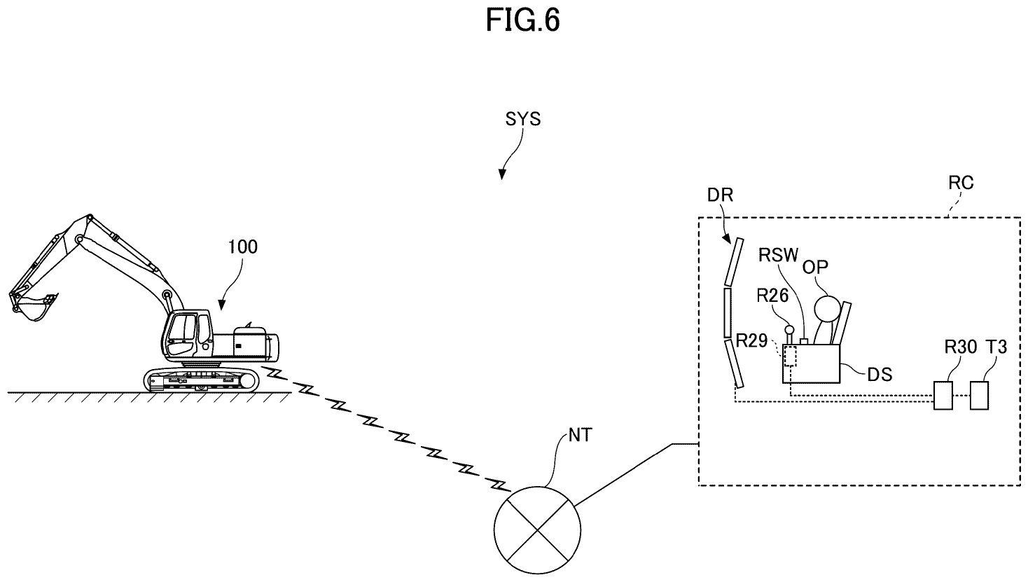

FIG. 6 is a schematic diagram illustrating a configuration example of a remote support system SYS for the excavator 100 according to the second embodiment. In the example illustrated in FIG. 6, the excavator 100 and a remote operation room RC are connected to each other via a communication network NW. Thus, transmission and reception of information can be realized between the excavator 100 and the remote operation room RC.

The excavator 100 transmits detection results from various sensors provided in the excavator 100 to the remote operation room RC using the communication device T1 provided in the excavator 100. For example, the excavator 100 transmits image information captured by the imaging device S6, a slewing angle, and detection results of various sensors to the remote operation room RC.

In the remote support system SYS according to the present embodiment, the remote operation room RC is provided. The remote operation room RC is provided with a display device DR, an operation device R26, an operation sensor R29, an operator's seat DS, a remote controller R30, and a communication device T3. The remote operation room RC is provided with a push start button RSW. Furthermore, the remote operation room RC may be provided with a structure similar to the cab 10 of the first embodiment, and may be provided with, for example, a gate lock lever and a short-range wireless communication device.

The remote controller R30 displays a display screen based on image information captured by the imaging device S6, a slewing angle, and detection results of the various sensors on the display device DR. Thus, an operator OP present in the operation seat DS can check the situation around the excavator 100 even when the operator OP is present in the remote operation room RC.

An operator OP present in the operator's seat DS of the remote operation room RC operates the operation device R26. The operation sensor R29 detects operation content received by the operation device R26. Then, the controller 30 generates a control signal corresponding to the operation content. Then, the communication device T3 transmits the generated control signal to the excavator 100. The remote controller R30 transmits a control signal, and thus the excavator 100 can be remotely operated. Furthermore, the remote controller R30 includes a configuration similar to that of the controller 30 of the above-described embodiment.

When the remote controller R30 of the remote operation room RC receives an operation on the push start button RSW from an operator OP, in the case where a condition for inhibiting the start of the engine 11 is not satisfied (in other words, in the case where a condition for starting the engine 11 is satisfied), the remote controller R30 transmits a control signal for starting the engine 11 to the excavator 100.

Specifically, the condition for inhibiting the start of the engine 11 may be the same as the condition in the first embodiment. For example, the condition may be: the key (for example, a smart key) for starting the engine 11 of the excavator 100 not being in the remote operation room RC, the gate lock lever provided in the remote operation room RC not being at the lock position, or the push start button RSW not being held down until the engine 11 is started. Furthermore, a condition corresponding to a remote operation may be included.

In the case where the remote controller R30 determines that the condition for inhibiting the start of the engine 11 is satisfied, the remote controller 30R causes the display device DR to display a pop-up screen indicating a method for starting the engine 11 corresponding to the condition. Thus, in the present embodiment, the same effects as those of the first embodiment can be obtained.

In the present embodiment, a notification of the method for starting the engine 11 is applied to a remote operation. However, the method of notifying a method for starting the engine 11 of the present embodiment is not limited to a method applied to a remote operation. For example, a notification of a method for starting the engine 11 may be applied to an excavator that performs autonomous control. In other words, in the case where an operator tries to start the engine of the excavator that performs the autonomous control by a predetermined operation, the controller of the excavator that performs the autonomous control may provide notification of a method for starting the engine.

### Advantageous Effects

In the foregoing embodiment, in response to receipt of a predetermined operation on the push start button, in the case where the condition for inhibiting the start of the engine is satisfied, the controller or the remote controller notifies an operator of the method for starting the engine corresponding to the condition. The operator can thus recognize the method for starting the engine. Therefore, the operation for starting the engine can be recognized immediately, and the engine can be started immediately to start the work, so that the work efficiency can be improved.

Although the embodiments of the excavator and the excavator operation control system according to the present disclosure have been described, the present disclosure is not limited to the foregoing embodiments and the like. Various changes, modifications, substitutions, additions, deletions, and combinations can be made within the scope of the claims. Such modifications are also included in the technical scope of the present disclosure.

What is claimed is:

1. An excavator, comprising:
a lower travel body;
an upper slewing body mounted on the lower travel body in a slewable manner;
an attachment attached to the upper slewing body;
a work tool provided at a distal end of the attachment;
a drive source;
a push button configured to start the drive source; and
a control section including a memory and a processor coupled to the memory, the control section being configured to issue a notification regarding a method for starting the drive source in response to receipt of a predetermined operation on the push button.

2. The excavator according to claim 1, wherein
the processor is configured to output one or more of sound, light, or character information as the notification.

3. The excavator according to claim 2, further comprising:
a display device, wherein
the processor is configured to cause the display device to display, as the notification, the character information indicating a method for starting the drive source.

4. The excavator according to claim 1, wherein
the processor is configured to perform, after the predetermined operation on the push button is received, notification regarding a method for starting the drive source, in a case where a predetermined condition regarding the start of the drive source is satisfied.

5. The excavator according to claim 3, wherein
the predetermined condition is one or more condition selected from among:
a condition that a length of time during which the push button is pressed is shorter than a length of time necessary to start the drive source,
a condition that a gate lock lever provided in a cab of the excavator is not at a lock position, and
a condition that a key for starting the excavator is not detected inside the cab of the excavator.

6. The excavator according to claim 1, wherein
the notification is a notification corresponding to the predetermined condition that is satisfied at a time of receiving the predetermined operation, among a plurality of types of notifications, and indicates a guidance of an operation performed by an operator of the excavator to start the drive source.

7. The excavator according to claim 1, further comprising:
a wireless communication device that is capable of communicating with a portable communication device that is portable by an operator, wherein
the push button is configured to be able to start the drive source when the push button is pressed while the wireless communication device is detecting the portable communication device.

8. An excavator operation control system, comprising:
an excavator including
a lower travel body,
an upper slewing body slewably mounted on the lower travel body,
an attachment attached to the upper slewing body,
a work tool provided at a distal end of the attachment, and
a drive source;
a push button for starting the drive source; and
a control section including a memory and a processor coupled to the memory, the control section being configured to issue a notification regarding a method for starting the drive source in response to receipt of a predetermined operation on the push button.
